(19) United States
(12) Patent Application Publication
(10) Pub. No.: US 2026/0359342 A1
(43) Pub. Date: Nov. 12, 2026

(54) AUTOMATIC CLUSTER NAMING USING FEATURES ON CYBERSECURITY TOPICS

(71) Applicant: CrowdStrike, Inc., Sunnyvale, CA (US)

(72) Inventors: Cristian Mircea Messel, Cluj-Napoca (RO); Liviu Marian Berciu, Cluj Napoca (RO); Dan Dinca, Voluntari (RO); Marian Radu, Bucharest (RO)

(21) Appl. No.: 19/199,681

(22) Filed: May 6, 2025

(51) Int. Cl. G06F 16/355; G06F 40/279

(52) U.S. Cl. CPC G06F 16/355; G06F 40/279

(57) ABSTRACT

The present disclosure provides techniques for automatic cluster naming using features on cybersecurity topics. A processing device generates, via a clustering technique, a plurality of clusters based on a plurality of user queries. The processing device extracts, via a keyword extraction technique, a set of keywords from user queries in each cluster in the plurality of clusters. The processing device assigns a name to each cluster in the plurality of clusters based on the set of keywords for each cluster in the plurality of clusters. The processing device causes each cluster in the plurality of clusters and the name for each cluster in the plurality of clusters to be presented on a display.

### TECHNICAL FIELD

Aspects of the present disclosure relate to cybersecurity, and more particularly, to automatic cluster naming using features on cybersecurity topics.

### BACKGROUND

Artificial intelligence (AI) is a field of computer science that encompasses the development of systems capable of performing tasks that typically require human intelligence. Machine learning is a branch of artificial intelligence focused on developing algorithms and models that allow computers to learn from data and make predictions or decisions without being explicitly programmed. Machine learning models are the foundational building blocks of machine learning, representing mathematical and computational frameworks used to extract patterns and insights from data. Large language models (LLMs), a category within machine learning models, are trained on vast amounts of text data to capture the nuances of language and context. By combining advanced machine learning techniques with enormous datasets, large language models harness data-driven approaches to achieve highly sophisticated language understanding and generation capabilities. AI models include machine learning models, large language models, and other types of models such as those based on neural networks, genetic algorithms, expert systems, Bayesian networks, reinforcement learning, decision trees, or combination thereof.

Cybersecurity refers to the practice of protecting computer systems, networks, and digital assets from theft, damage, unauthorized access, and various forms of cyber threats. Cybersecurity threats encompass a wide range of activities and actions that pose risks to the confidentiality, integrity, and availability of computer systems and data. These threats can include malicious activities such as viruses, ransomware, and hacking attempts aimed at exploiting vulnerabilities in software or hardware.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example of a system for automatic cluster naming using features on cybersecurity topics in accordance with some aspects of the present disclosure.

FIG. 2 is a diagram illustrating an example of a graphical user interface (GUI) for displaying clusters and cluster names in accordance with some aspects of the present disclosure.

FIG. 3 is a flow diagram of a method of automatic cluster naming using features on cybersecurity topics in accordance with some aspects of the present disclosure.

FIG. 4 is a flow diagram of a method of automatic cluster naming using features on cybersecurity topics in accordance with some aspects of the present disclosure.

FIG. 5 is a block diagram that illustrates an example of a system for automatic cluster naming using features on cybersecurity topics in accordance with some aspects of the present disclosure.

FIG. 6 illustrates a diagrammatic representation of a machine in an example form of a computer system that may perform one or more of the operations described herein in accordance with some aspects of the present disclosure.

### DETAILED DESCRIPTION

Unsupervised learning (which may also be referred to as unsupervised machine learning), may refer to a technique to find patterns in unlabeled data without human guidance. An example of unsupervised learning may include clustering. Clustering groups unlabeled examples (i.e., data) based on similarity of the unlabeled examples to one another. For example, clustering may be used to group users that have similar characteristics to the same cluster. One challenge when performing clustering is determining a suitable number of clusters in which unlabeled examples are to be grouped. If too few clusters are used, then a cluster may include examples that are not related to one another, and hence deriving insights from the clusters may be challenging; however, if too many clusters are used, then a cluster may be too specific, which may also make deriving insights from the clusters challenging. Furthermore, in some cases, after clustering is performed, an example may belong to more than one cluster (referred to as cluster overlap), which may not be desirable in some cases. Eliminating cluster overlap may entail executing repeated instances of a clustering algorithm, which may waste computing resources and may be tedious for a user.

One manner in which to reduce cluster overlap and/or to determine if a suitable number of clusters are being utilized may be to assign unique names (i.e., labels) to each cluster. A name assigned to a cluster may serve as a summary of all examples in the cluster. After unique names are assigned to each cluster, an automated or manual inspection of examples in the cluster may be performed to determine whether each example in the cluster truly belongs in the cluster. Current techniques for cluster naming may not include functionality for automatically performing clustering, automatically identifying cluster overlap, automatically adjusting a number of clusters, and automatically assigning semantically meaningful names to clusters.

The present disclosure addresses the above-noted and other deficiencies by using a processing device to perform automatic cluster naming. In an example, a processing device may obtain user queries from user devices. In an example, the user queries pertain to functionality of a cybersecurity application. For instance, the user queries may include “How do I know if the cybersecurity application is running on my device?” and “How do I run the cybersecurity application?” The user queries may be set forth to the cybersecurity application and/or a search engine. The processing device may automatically cluster the user queries into clusters using a clustering technique (e.g., partition-based clustering, hierarchical clustering, etc.). For example, the aforementioned user queries may be clustered into one cluster. The processing device may then automatically extract keywords from each cluster using a keyword extraction technique (e.g., term frequency-inverse document frequency (TF-IDF)). The processing device may assign names (e.g., semantically meaningful names) to each cluster based on the set of keywords. The processing device may then present the clusters, one or more user queries belonging to each cluster, and respective names for each clusters on a display. Insights into the user queries may then be gathered based on the cluster names.

In an example, a processing device generates, via a clustering technique, a plurality of clusters based on a plurality of user queries. The processing device extracts, via a keyword extraction technique, a set of keywords from user queries in each cluster in the plurality of clusters. The processing device assigns a name to each cluster in the plurality of clusters based on the set of keywords for each cluster in the plurality of clusters. The processing device causes each cluster in the plurality of clusters and the name for each cluster in the plurality of clusters to be presented on a display.

As discussed herein, the present disclosure provides an approach that improves the operation of a computer system by automatically performing both clustering and cluster naming, thus conserving computing resources. In addition, the present disclosure provides an improvement to the technological field of cybersecurity by providing insights into use of cybersecurity products by users. For example, vis-à-vis assigning names to clusters as described above, areas of interest of a cybersecurity application may be discovered. In some examples, if a cluster name indicates that users of the cybersecurity application are frequently asking about functionality of the cybersecurity application, training may be provided on how to use the functionality. In other examples, if the functionality is not currently enabled in the cybersecurity application, the functionality can be enabled.

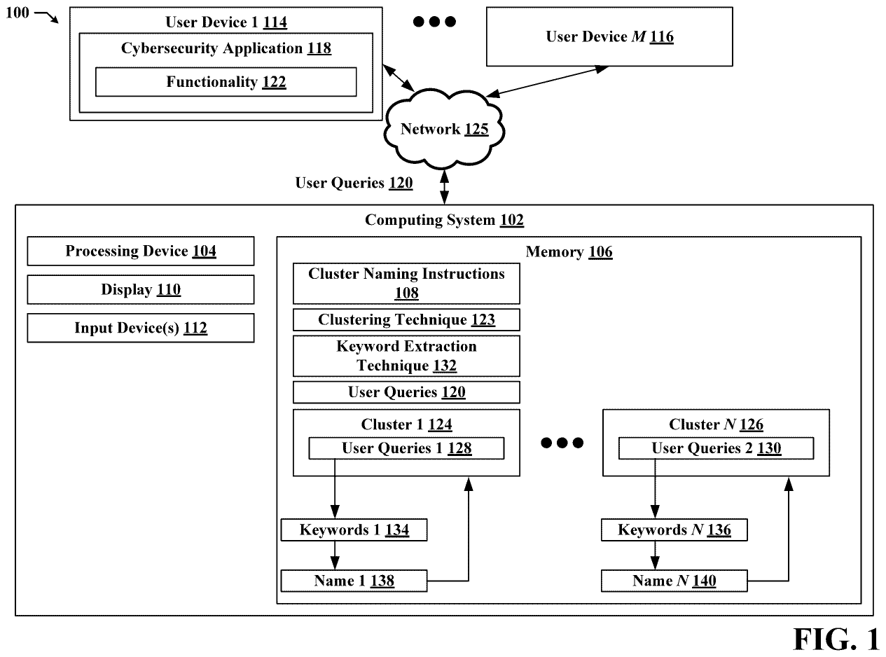

FIG. 1 is a block diagram 100 that illustrates an example of a system for automatic cluster naming using features on cybersecurity topics in accordance with some aspects of the present disclosure. The system includes a computing system 102. In an example, the computing system 102 may be or include a desktop computing device, a laptop computing device, a tablet computing device, and/or a smartphone. In another example, the computing system 102 may be or include a server computing device, such as a cloud-based server computing device. In an example, the computing system 102 may be or include the computer system 600 (or a portion thereof). In an example, the computing system 102 may be associated with an organization that provides cybersecurity services to clients (i.e., other organizations).

The computing system 102 includes a processing device 104 (e.g., a central processing unit (CPU)) and memory 106. The memory 106 stores cluster naming instructions 108 that, when executed by the processing device 104, cause the processing device 104 to implement functionality pertaining to automatic cluster naming using features on cybersecurity topics as described herein.

The computing system 102 may include a display 110 that may display graphical features (e.g., a GUI). The computing system 102 may include input device(s) 112. In an example, the input device(s) 112 may be or include a keyboard, a mouse, and/or a touchscreen. It is to be understood that the computing system 102 may include elements in addition to those depicted in FIG. 1 (e.g., a network interface card).

The system further includes a first user device 114 and an Mth user device 116, where M is a positive integer greater than one. The first user device 114 and the Mth user device 116 may be collectively referred to as a plurality of user devices 114-116. In an example, the plurality of user devices 114-116 may be or include desktop computing devices, laptop computing devices, tablet computing devices, and/or smartphones. In an example, the first user device 114 and/or the Mth user device 116 may be or include the computer system 600 (or a portion thereof). In some examples, each of the plurality of user devices 114-116 may be associated with an organization (e.g., a corporation). For instance, the organization may control (e.g., own) each of the plurality of user devices 114-116 and the plurality of user devices 114-116 may be operated by employees of the organization.

In an example, the first user device 114 may execute a cybersecurity application 118. The cybersecurity application 118 may include computer-executable instructions that, when executed by a processing device, cause the processing device to protect against cybersecurity threats (e.g., computer threats and/or network threats). In some examples, the cybersecurity application 118 may use AI, threat intelligence, and real-time attack indicators to detect and address threats. In some examples, the cybersecurity application 118 may monitor and record logins, programs, and files on the first user device 114. In some examples, the cybersecurity application 118 may use threat intelligence to identify and prioritize vulnerabilities of the first user device 114 and/or a network to which the first user device 114 belongs. In some examples, the cybersecurity application 118 may use real-time indicators to automatically protect against cybersecurity threats. In some examples, the cybersecurity application 118 may be part of a cloud based application that executes partly on the first user device 114 and partly in the cloud (not depicted in FIG. 1). Although not depicted in FIG. 1, it is to be understood that the Mth user device 116 may also execute a cybersecurity application that is similar or identical to the cybersecurity application 118.

The plurality of user devices 114-116 may receive, as input to cybersecurity applications (e.g., the cybersecurity application 118) and/or search engines (not depicted in FIG. 1), user queries 120. In an example, the user queries 120 may pertain to functionality 122 provided by the cybersecurity application 118. In an example, the functionality 122 may be related to how to operate or utilize a feature of the cybersecurity application 118, and as such, the user queries 120 may include “How do I view logs of program execution?” “Frequently asked questions on execution logs in the cybersecurity application,” “How do I view a detection?” and/or “View program logs.” In another example, the functionality 122 may be related to AI capabilities of the cybersecurity application 118 (which may or may not be enabled for the plurality of user devices 114-116).

In some aspects, the plurality of user devices 114-116 may generate the user queries 120 based on input received by the cybersecurity application 118. For example, the cybersecurity application 118 may display user interface (UI) elements which may be selected by a user. The UI elements may have assigned names. For example, a button of the cybersecurity application 118 may have an assigned name of “view logs.” The cybersecurity application 118 may generate the user queries 120 based on names of selected UI elements of the cybersecurity application 118.

The plurality of user devices 114-116 may transmit, to the computing system 102 and over a network 125 (e.g., the Internet, a local area network (LAN), etc.) the user queries 120. In some examples, the plurality of user devices 114-116 may receive input which causes the plurality of user devices 114-116 to transmit the user queries 120. In some examples, the cybersecurity application 118 may transmit the user queries 120 to the computing system 102. In some examples, a browser plug-in executing on the plurality of user devices 114-116 may cause the plurality of user devices 114-116 to transmit the user queries 120 to the computing system 102. The computing system 102 may receive the user queries from the plurality of user devices 114-116 and store the user queries 120 in the memory 106 (or other data storage of the computing system 102).

The computing system 102 may generate, via a clustering technique 123, a first cluster 124 and an Nth cluster 126, where N is a positive integer greater than one. The first cluster 124 and the Nth cluster 126 may be collectively referred to as a plurality of clusters 124-126. The first cluster 124 may include first user queries 128 from the user queries 120 and the Nth cluster 126 may include second user queries 130 from the user queries 120. Each of the first user queries 128 in the first cluster 124 may be related to a first topic and each of the second user queries 130 in the Nth cluster 126 may be related to a second topic. In an example, the first user queries 128 in the first cluster 124 may include “How do I view logs of program execution?” “Frequently asked questions on execution logs in the cybersecurity application,” and “View program logs” and the second user queries 130 in the Nth cluster 126 may include “How do I view a detection?”

In some aspects, the computing system 102 may generate embeddings for each user query in the user queries 120. The embeddings may map features of the user queries 120 to a vector in an embedding space that includes fewer dimensions than dimensions of the user queries 120. The computing system 102 may generate the plurality of clusters 124-126 based on the embeddings.

In an example, the clustering technique 123 may be or include centroid-based clustering, density-based clustering, distribution-based clustering, hierarchical clustering, and/or graph clustering. Centroid-based clustering may refer to a technique to organize data (e.g., the user queries 120) into non-hierarchical clusters. A centroid of a cluster may refer to an arithmetic mean of all points in the cluster. In an example of centroid-based clustering may include k-means clustering. Density-based clustering may refer to a technique to connect contiguous areas of high example density into clusters. Distribution-based clustering may refer to a technique that assumes that data (e.g., the user queries 120) is composed of probabilistic distributions (e.g., Gaussian distributions). Hierarchical clustering may refer to a technique that creates a tree of clusters. Graph clustering may refer to a technique that partitions nodes in a graph into related sets based on edge structure(s).

In some aspects, the plurality of clusters 124-126 may include a first number of clusters. The computing system 102 may identify an overlap between at least two clusters in the plurality of clusters 124-126. An overlap may refer to a user query belonging to more than one cluster. The computing system 102 may automatically generate a second plurality of clusters (not shown in FIG. 1) that includes a second number of clusters, where the second number of clusters is different from the first number of clusters. The computing system 102 may continue this process until no overlaps are found. The second plurality of clusters may then serve as the plurality of clusters 124-126.

The computing system 102 may extract, via a keyword extraction technique 132, first keywords 134 from the first user queries 128 in the first cluster 124. The computing system may also extract, via the keyword extraction technique 132, Nth keywords 136 from the second user queries 130 in the Nth cluster 126. The first keywords 134 may be associated with the first user queries 128 and the Nth keywords 136 may be associated with the second user queries 130. In some aspects, the computing system 102 may extract the first keywords 134 with first keyword extraction technique(s) and the computing system 102 may extract the Nth keywords 136 with second keyword extraction technique(s), where the first keyword extraction technique(s) and the second keyword extraction technique(s) are different.

In an example, the keyword extraction technique 132 may be or include or be associated with term frequency, TF-IDF, a bag-of-words model, cosine similarity, or Euclidean distance. Term frequency may refer to a statistical measure of how often a word or phrase appears in a document (e.g., the first user queries 128, the second user queries 130, etc.). TF-IDF may refer to a measure of an importance of a word in a document (e.g., the first user queries 128, the second user queries 130, etc.) adjusted for certain words appearing more frequently in general. A bag-of-words model may refer to a model of text which uses an ordered collection (a bag) of words. Cosine similarity may refer to a measure of similarity between two non-zero vectors defined in an inner product space. Cosine similarity may be a cosine of an angle between the two vectors, that is, a dot product of the two vectors divided by a product of lengths of the two vectors. Euclidian similarity may refer to a similarity metric that measure how similar two pieces of text (e.g., user queries) are by calculating a Euclidean distance between vector representations of the two pieces of text. In some aspects, the keyword extraction technique 132 may include zero-shot classification. Zero-shot classification may refer to an ML technique where a model can categorize data into different classes without having been specifically trained on examples from the different classes. In some aspects, the keyword extraction technique 132 may include topic modelling. Topic modeling may refer to an unsupervised learning technique used in natural language processing (NLP) to identify recurring themes/topics within a collection of documents (e.g., the first user queries 128, the second user queries 130, etc.) by analyzing word frequencies and grouping related words together. In some aspects, the keyword extraction technique 132 may include named entity recognition. Named entity recognition may refer to a way of identifying and classifying important information in text (e.g., the first user queries 128, the second user queries 130, etc.) and can identify people, places, organizations, products, dates, etc.

The computing system 102 may assign a first name 138 to the first cluster 124 based on the first keywords 134 and the computing system 102 may assign an Nth name 140 to the Nth cluster 126 based on the Nth keywords 136. The first name 138 and the Nth name 140 may each include one or more words. The first name 138 and the Nth name 140 may also be referred to as a first label and an Nth label. In some aspects, the first name 138 and/or the Nth name 140 may include all of the first keywords 134 and all of the Nth keywords 136, respectively. In some aspects, the first name 138 and/or the Nth name 140 may include a portion of the first keywords 134 and a portion of the Nth keywords 136, respectively. In some aspects, the computing system 102 may add additional words (e.g., prepositions, articles, etc.) to some or all of the first keywords 134 and some or all of the Nth keywords 136 to generate and assign the first name 138 and the Nth name 140, respectively.

In some aspects, the computing system 102 may rank each keyword in the first keywords 134 based on an importance of a word for a cluster adjusted for frequency of the word. The computing system 102 may also rank each keyword in the Nth keywords 136 based on an importance of a word for a cluster adjusted for frequency of the word. The computing system 102 may assign the first name 138 to the first cluster 124 and the Nth name 140 to the Nth cluster 126 based at least in part on the rankings. For example, the computing system 102 may assign the first name 138 to the first cluster 124 based on a certain number of highest ranked keywords in the first keywords 134 and the computing system 102 may assign the Nth name 140 to the Nth cluster 126 based on a certain number of highest ranked keywords in the Nth keywords 136.

The computing system 102 may cause the first cluster 124, the first name 138 for the first cluster 124, the Nth cluster 126, and the Nth name 140 for the Nth cluster 126 to be presented. In one example, the computing system 102 may present the first cluster 124, the first name 138 for the first cluster 124, the Nth cluster 126, and the Nth name 140 for the Nth cluster 126 on the display 110. In another example, the computing system 102 may transmit data over the network 125 which causes a user device in the plurality of user devices 114-116 (or another device) to display the first cluster 124, the first name 138 for the first cluster 124, the Nth cluster 126, and the Nth name 140 for the Nth cluster 126. In some aspects, the computing system 102 may cause at least one query in the first user queries 128 and at least one query in the second user queries 130 to be presented concurrently with the first cluster 124, the first name 138 for the first cluster 124, the Nth cluster 126, and the Nth name 140 for the Nth cluster 126.

Although the description above focuses on clustering of cybersecurity topics, it is to be understood that the ideas described herein are applicable to domains other than cybersecurity. Additionally, in some aspects, the computing system 102 may be included in the plurality of user devices 114-116.

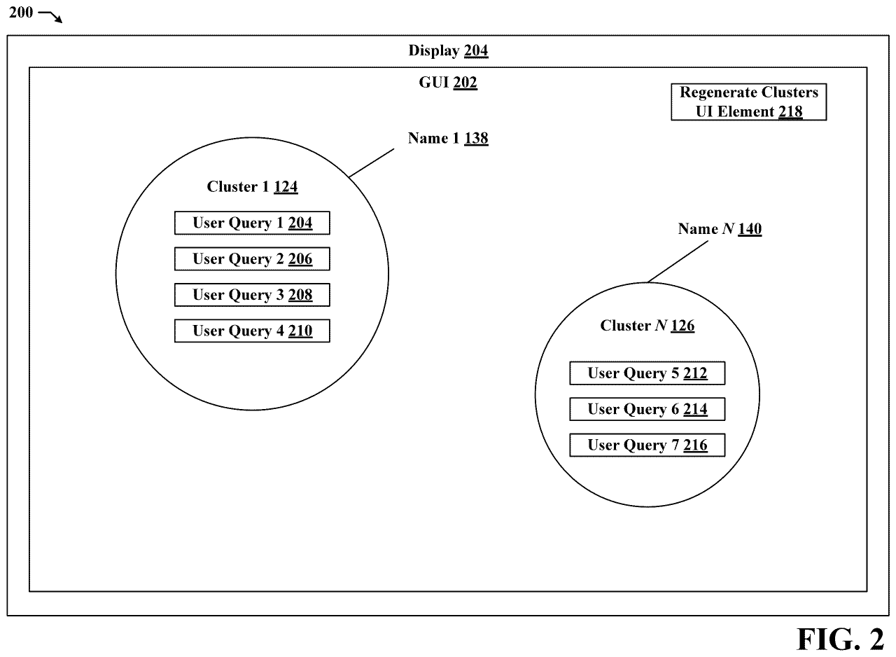

FIG. 2 is a diagram illustrating an example of a GUI 202 for displaying clusters and cluster names in accordance with some aspects of the present disclosure. Referring jointly now to FIG. 1 and FIG. 2, the GUI 202 may be presented on the display 110 of the computing system 102 (or another device, such as the first user device 114). In an example, the computing system 102 may be operated by a user with decision making authority (e.g., a manager) for an organization. In an example, the computing system 102 may present the GUI 202 on the display 110 after assigning names to the plurality of clusters 124-126 as described above in the description of FIG. 1.

The GUI 202 may include the first cluster 124 and the first name 138 assigned to the first cluster 124. The GUI 202 may include the Nth cluster 126 and the Nth name 140 assigned to the Nth cluster 126. In some aspects, a size of the first cluster 124 and a size of the Nth cluster 126 in the GUI 200 may be based on a number of queries in the first cluster 124 and the Nth cluster 126, respectively.

In an example, the GUI 202 may include a first user query 204, a second user query 206, a third user query 208, and a fourth user query 210, where the first user query 204, the second user query 206, the third user query 208, and the fourth user query 210 are from the first user queries 128. In the example, the GUI 202 may also include a fifth user query 212, a sixth user query 214, and a seventh user query 216, where the fifth user query 212, the sixth user query 214, and the seventh user query 216 are from the second user queries 130. The GUI 202 may enable a visual inspection of the clustering to be performed in order to determine if the clustering was properly performed. In an example, the first name 138 for the first cluster 124 is “program execution logs of cybersecurity application.” In another example, the Nth name 140 for the Nth cluster 126 is “AI functionality of cybersecurity application.” In some aspects, a number of queries included in the first cluster 124 and the Nth cluster 126 may be presented in the GUI 202.

The GUI 202 may include a regenerate clusters UI element 218 that, when selected, may cause the computing system 102 to perform the cluster generation and naming processes described above to be repeated using the clustering technique 123 with different parameter(s), a different clustering technique, the keyword extraction technique 132 with different parameter(s), and/or a different keyword extraction technique. The computing system may then present (new) clusters and (new) names for the clusters on the GUI 200. In one example, the regenerate clusters UI element 218 may be selected when the second user query 206 is not associated with the first name 138 for the first cluster 124. This may indicate that there are not enough clusters in the plurality of clusters 124-126, and as such, the computing system may generate a number of clusters that is greater than the previously generated number of clusters. In another example, the regenerate clusters UI element 218 may be selected when the first user query 204, the second user query 206, the third user query 208, and the fourth user query 210 and/or the first name 138 is similar to the Nth name 140. This may indicate that there are too many clusters in the plurality of clusters 124-126, and as such, the computing system may generate a number of clusters that is less than the previously generated number of clusters.

In some aspects, the computing system 102 may associate the first name 138 for the first cluster 124 and/or the Nth name 140 to the Nth clusters 126 to the functionality 122 of the cybersecurity application 118. The computing system 102 may obtain an indication of a selection of the first name 138. The computing system 102 may cause the functionality 122 (or an associated functionality) to be provided by the cybersecurity application 118 based on the association.

In an example, the first name 138 for the first cluster 124 is “program execution logs of cybersecurity application” and the functionality 122 of the cybersecurity application 118 is program execution logs. In the example, due to the amount of queries in the first cluster 124, users may be having trouble viewing program execution logs of the cybersecurity application 118. The computing system 102 may receive a selection of the first name 138 in the GUI 202. The computing system 102 may then cause training to be provided on how to view a program execution log to the plurality of user devices 114-116 based on the selection. For instance, the computing system 102 may cause a tool-tip to appear in a GUI for the cybersecurity application 118 or the computing system 102 may transmit a message to the plurality of user devices 114-116 that includes a tutorial on how to view a program execution log.

In another example, the Nth name 140 for the Nth cluster 126 may be “AI functionality of cybersecurity application” and the functionality 122 of the cybersecurity application 118 may be AI features to detect cybersecurity threats. In the example, the cybersecurity application 118 may be capable of providing AI features to detect cybersecurity threats, but such functionality may not currently be enabled for an organization to which the plurality of user devices 114-116 belong. In the example, due to the amount of queries in the Nth cluster 126, users may be interested in AI features. The computing system 102 may receive a selection of the Nth name 140 in the GUI 202. The computing system 102 may then cause the AI features to be enabled for cybersecurity applications (e.g., the cybersecurity application 118). For instance, the computing system 102 may transmit data to the first user device 114 that causes the AI features of the cybersecurity application 118 to be enabled and/or installed on the first user device 114.

Determining an optimal number of k clusters (k is a positive integer) to be used when applying an unsupervised learning algorithm (e.g., an unsupervised machine learning algorithm) may help to reduce overlap between cluster and to ensure proper segregation of data. Determining an optimal number of clusters can be a tedious, iterative, and repetitive process which can be improved by automatically naming clusters.

Proper cluster names can help to verify if an observation belongs to a cluster centroid and may indicate if a different number of k clusters should be used. When aiming to maximize coverage of observations by extracting a minimal set of meaningful samples, determining if a random sample from within a cluster actually should belong to the cluster can be achieved by naming the cluster. However, it may be difficult to provide a proper name for a cluster without obtaining insight from all data upon which clusters are generated. Thus, an automatic method for naming clusters may be useful. The name may serve as a summary of all samples which belong to a cluster. Some existing techniques for cluster generation (e.g., cluster techniques within the cybersecurity domain) may not automatically name (i.e., label, such as a categorical labeling) clusters using top features measured by the importance of a word to a cluster adjusted for frequency with the aim to name the cluster, may not automatically identify cluster overlap, and may not signal a need to change the number of clusters. Furthermore, existing techniques for cluster generation may not be incorporated into a domain-specific product, such as a cybersecurity application.

Some aspects described herein pertain to techniques to generate clusters. Example techniques for clustering may include partition-based clustering, hierarchical clustering, density-based clustering, topic modelling, and graph clustering. Techniques for clustering may range from simple clusterization techniques using raw data to more complex embedding based techniques.

Some aspects described herein pertain to techniques to extract keywords from clusters. Example techniques to extract keywords may include term frequency techniques, such as term frequency and TF-IDF and distance-based techniques, such as cosine similarity and Euclidean distance. Other example techniques to extract keywords may include summarization techniques, top N words (N is an integer), named entity recognition, and zero-shot classification. The techniques to extract the keywords may provide a meaningful label for a cluster.

Some aspects described herein pertain to using the automatic naming of clusters in a product, such as a cybersecurity AI product. Clients of a cybersecurity provider may use the techniques described herein to extract information about systems of the clients. User data may be ingested into a cybersecurity application and the techniques described herein may be used to automatically perform clustering and labelling (i.e., naming). Category labels (i.e., names) may allow stakeholders to find areas of user interest, knowledge hotspots, weak areas, and/or areas to improve upon products.

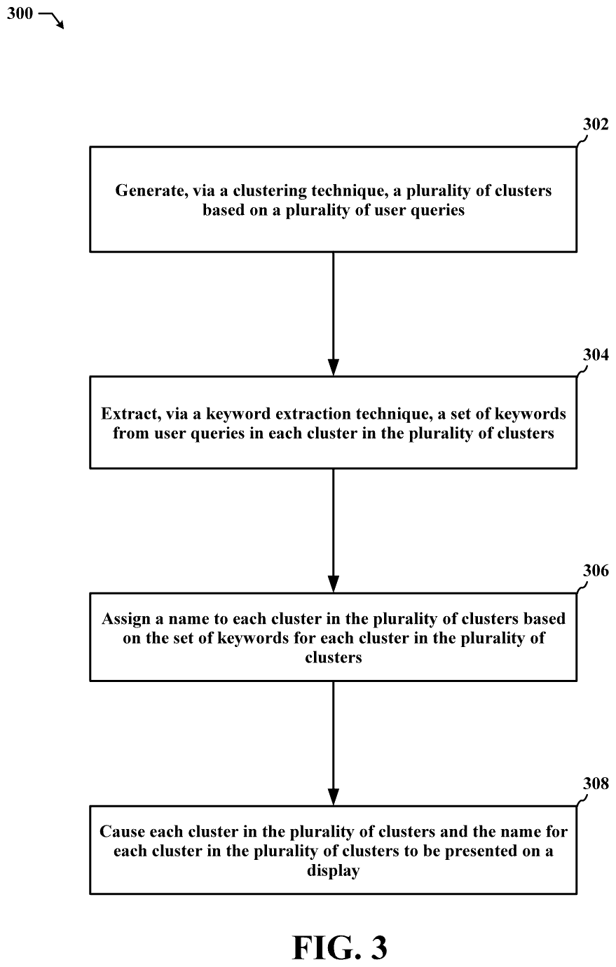

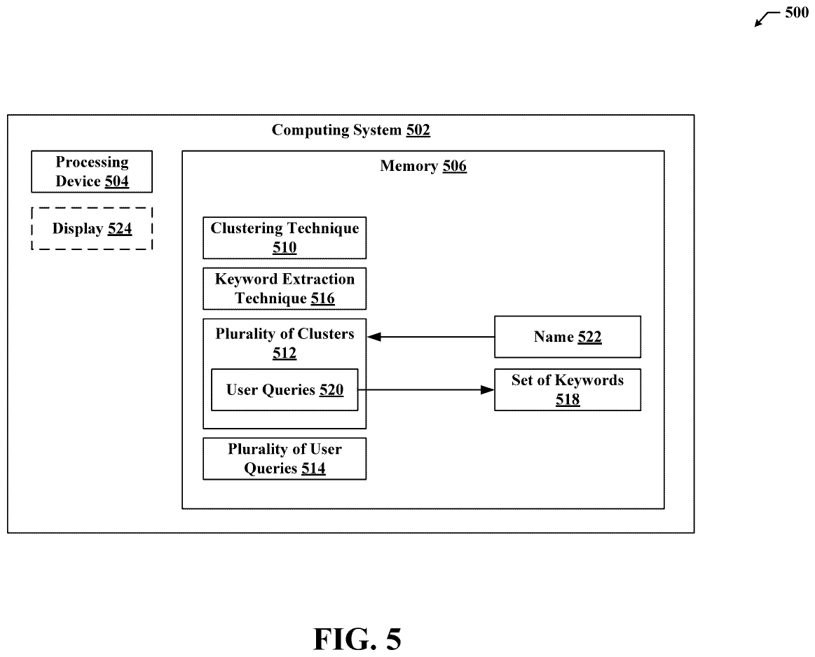

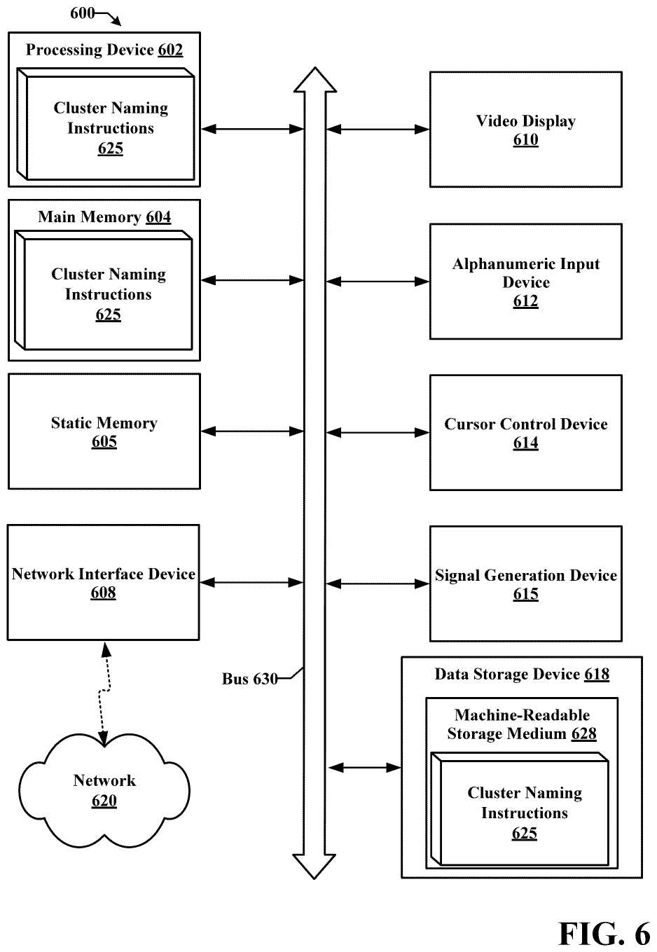

FIG. 3 is a flow diagram 300 of a method for automatic cluster naming using features on cybersecurity topics in accordance with some aspects of the present disclosure. The method may be performed by processing logic that may include hardware (e.g., a processing device), software (e.g., instructions running/executing on a processing device), firmware (e.g., microcode), or a combination thereof. In some aspects, at least a portion of the method may be performed by the computing system 102 (shown in FIG. 1), the processing device 104 (shown in FIG. 1), the computing system 502 (shown in FIG. 5), the processing device 504 (shown in FIG. 5), the computer system 600 (shown in FIG. 6), the processing device 602 (shown in FIG. 6), or a combination thereof.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

At block 302, a processing device generates, via a clustering technique, a plurality of clusters based on a plurality of user queries. In an example, the clustering technique may be or include the clustering technique 123, the plurality of clusters may be or include the plurality of clusters 124-126, and the plurality of queries may be or include the user queries 120. In another example, the clustering technique may be or include the clustering technique 510, the plurality of clusters may be or include plurality of clusters 512, and the plurality of user queries may be or include the plurality of user queries 514.

At block 304, the processing device extracts, via a keyword extraction technique, a set of keywords from user queries in each cluster in the plurality of clusters. In an example, the keyword extraction technique may be or include the keyword extraction technique 132 and the set of keywords may be or include the first keywords 134 and/or the Nth keywords 136. In another example, the keyword extraction technique may be or include the keyword extraction technique 516 and the set of keywords may be or include the set of keywords 518.

At block 306, the processing device assigns a name to each cluster in the plurality of clusters based on the set of keywords for each cluster in the plurality of clusters. In an example, the names assigned to each cluster may be or include the first name 138 and Nth name 140. In another example, the name may be or include the name 522.

At block 308, the processing device causes each cluster in the plurality of clusters and the name for each cluster in the plurality of clusters to be presented on a display. In an example, the display may be or include the display 110. In another example, the display may be or include the display 524.

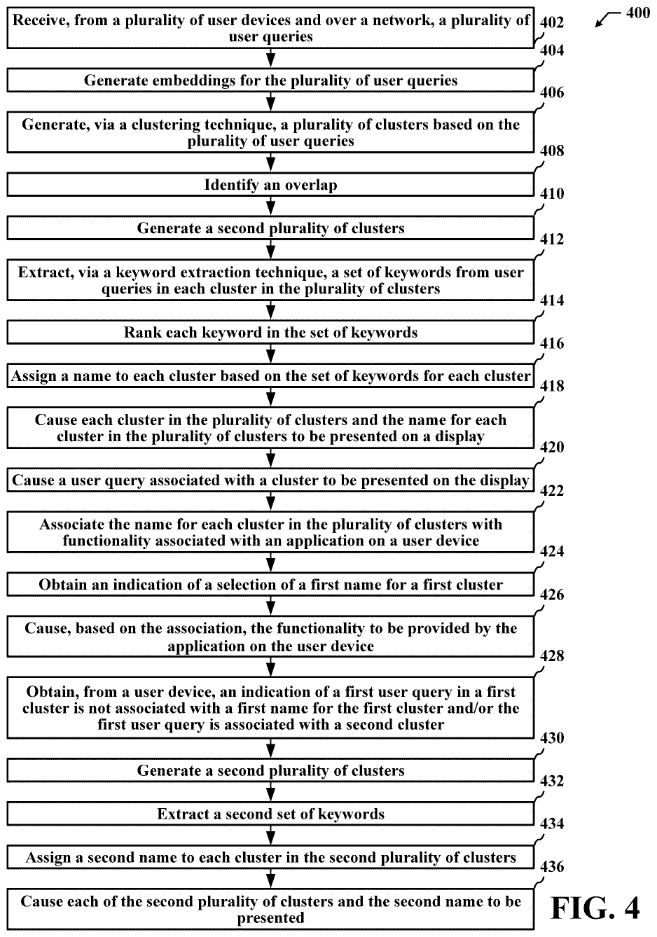

FIG. 4 is a flow diagram 400 of a method for automatic cluster naming using features on cybersecurity topics in accordance with some aspects of the present disclosure. The method may be performed by processing logic that may include hardware (e.g., a processing device), software (e.g., instructions running/executing on a processing device), firmware (e.g., microcode), or a combination thereof. In some aspects, at least a portion of the method may be performed by the computing system 102 (shown in FIG. 1), the processing device 104 (shown in FIG. 1), the computing system 502 (shown in FIG. 5), the processing device 504 (shown in FIG. 5), the computer system 600 (shown in FIG. 6), the processing device 602 (shown in FIG. 6), or a combination thereof.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

In some aspects, at block 402, a processing device may receive, from a plurality of user devices and over a network, a plurality of user queries. Generating a plurality of clusters may be based on the received plurality of user queries. For example, the plurality of user devices may be or include the plurality of user devices 114-116 and the network may be or include the network 125. In another example, the plurality of user queries may be or include the plurality of user queries 514.

In some aspects, at block 404, the processing device may generate embeddings for the plurality of user queries. Generating the plurality of clusters may be based on the embeddings. For example, the aforementioned aspect may correspond to aspects described above in the description of FIG. 1.

At block 406, the processing device generates, via a clustering technique, a plurality of clusters based on a plurality of user queries. In an example, the clustering technique may be or include the clustering technique 123, the plurality of clusters may be or include the plurality of clusters 124-126, and the plurality of queries may be or include the user queries 120. In another example, the clustering technique may be or include the clustering technique 510, the plurality of clusters may be or include plurality of clusters 512, and the plurality of user queries may be or include the plurality of user queries 514.

In some aspects, at block 408, the processing device may identify an overlap between a first cluster in the plurality of clusters and a second cluster in the plurality of clusters. For example, the aforementioned aspect may correspond to aspects described above in the description of FIG. 1.

In some aspects, at block 410, the processing device may generate, based on a modification to the clustering technique, a second plurality of clusters based on the plurality of user queries, where each cluster in the second plurality of clusters may be non-overlapping. Extracting the set of keywords and the assigning the name to each cluster may be based on the second plurality of clusters. For example, the aforementioned aspect may correspond to aspects described above in the description of FIG. 1.

At block 412, the processing device extracts, via a keyword extraction technique, a set of keywords from user queries in each cluster in the plurality of clusters. In an example, the keyword extraction technique may be or include the keyword extraction technique 132 and the set of keywords may be or include the first keywords 134 and/or the Nth keywords 136. In another example, the keyword extraction technique may be or include the keyword extraction technique 516 and the set of keywords may be or include the set of keywords 518.

In some aspects, at block 414, the processing device may rank each keyword in the set of keywords based on an importance of a word for a cluster adjusted for frequency of the word. Assigning the name to each cluster in the plurality of clusters may be based on a top P ranked keywords in the set of keywords, where P is a positive integer. For example, the aforementioned aspect may correspond to aspects described above in the description of FIG. 1.

At block 416, the processing device assigns a name to each cluster in the plurality of clusters based on the set of keywords for each cluster in the plurality of clusters. In an example, the names assigned to each cluster may be or include the first name 138 and Nth name 140. In another example, the name may be or include the name 522.

At block 418, the processing device causes each cluster in the plurality of clusters and the name for each cluster in the plurality of clusters to be presented on a display. In an example, the display may be or include the display 110. In another example, the display may be or include the display 524

In some aspects, at block 420, the processing device may cause, for a cluster in the plurality of clusters, a user query associated with the cluster to be presented on the display. For example, the aforementioned aspect may correspond to aspects described above in the description of FIG. 2.

In some aspects, at block 422, the processing device may associate the name for each cluster in the plurality of clusters with functionality associated with an application on the user device, where the application may fail to provide the functionality. For example, the aforementioned aspect may correspond to aspects described above in the description of FIG. 2.

In some aspects, at block 424, the processing device may obtain an indication of a selection of a first name for a first cluster in the plurality of clusters. For example, the aforementioned aspect may correspond to aspects described above in the description of FIG. 2.

In some aspects, at block 426, the processing device may cause, based on the association, the functionality to be provided by the application on the user device. For example, the aforementioned aspect may correspond to aspects described above in the description of FIG. 2.

In some aspects, at block 428, the processing device may obtain, from a user device, an indication of at least one of: a first user query in a first cluster in the plurality of clusters is not associated with a first name for the first cluster or the first user query in the first cluster is associated with a second cluster in the plurality of clusters. For example, the aforementioned aspect may correspond to aspects described above in the description of FIG. 2.

In some aspects, at block 430, the processing device may generate, via the clustering technique and based on the indication, a second plurality of clusters based on the plurality of user queries, wherein the plurality of clusters may include a first number of clusters and the second plurality of clusters may include a second number of clusters, where the first number of clusters may be different from the second number of clusters. For example, the aforementioned aspect may correspond to aspects described above in the description of FIG. 2.

In some aspects, at block 432, the processing device may extract, via the keyword extraction technique, a second set of keywords from second user queries in each cluster in the second plurality of clusters. For example, the aforementioned aspect may correspond to aspects described above in the description of FIG. 2.

In some aspects, at block 434, the processing device may assign a second name to each cluster in the second plurality of clusters based on the second set of keywords for each cluster in the second plurality of clusters. For example, the aforementioned aspect may correspond to aspects described above in the description of FIG. 2.

In some aspects, at block 436, the processing device may cause each cluster in the second plurality of clusters and the second name for each cluster in the second plurality of clusters to be presented on the display. For example, the aforementioned aspect may correspond to aspects described above in the description of FIG. 2.

FIG. 5 is a block diagram 500 that illustrates an example of a computing system 502 for automatic cluster naming using features on cybersecurity topics in accordance with some aspects of the present disclosure. In some aspects, the computing system 502 may perform some or all of the functionality described herein. The computing system 502 includes a processing device 504 and memory 506. The memory 506 is operatively coupled to the processing device 504. The processing device 504 is to generate, via a clustering technique 510, a plurality of clusters 512 based on a plurality of user queries 514. The processing device 504 is to extract, via a keyword extraction technique 516, a set of keywords 518 from user queries 520 in each cluster in the plurality of clusters 512. The processing device 504 is to assign a name 522 to each cluster in the plurality of clusters 512 based on the set of keywords 518 for each cluster in the plurality of clusters 512. The processing device 504 is to cause each cluster in the plurality of clusters 512 and the name 522 for each cluster in the plurality of clusters 512 to be presented on a display 524.

FIG. 6 illustrates a diagrammatic representation of a machine in the example form of a computer system 600 within which a set of instructions, for causing the machine to perform any one or more of the methodologies discussed herein for automatic cluster naming using features on cybersecurity topics.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, the computer system 600 may be representative of a server.

The computer system 600 includes a processing device 602, a main memory 604 (e.g., read-only memory (ROM), flash memory, dynamic random access memory (DRAM), a static memory 605 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 600 may further include a network interface device 608 which may communicate with a network 620. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 615 (e.g., an acoustic signal generation device, such as a speaker). In some embodiments, the video display unit 610, the alphanumeric input device 612, and the cursor control device 614 may be combined into a single component or device (e.g., an LCD touch screen).

The processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute cluster naming instructions 625, for performing the operations and steps discussed herein. For example, the cluster naming instructions 625 may include instructions for generating, via a clustering technique, a plurality of clusters based on a plurality of user queries. The cluster naming instructions 625 may include instructions for extracting, via a keyword extraction technique, a set of keywords from user queries in each cluster in the plurality of clusters. The cluster naming instructions 625 may include instructions for assigning, a name to each cluster in the plurality of clusters based on the set of keywords for each cluster in the plurality of clusters. The cluster naming instructions 625 may include instructions for causing each cluster in the plurality of clusters and the name for each cluster in the plurality of clusters to be presented on a display.

The data storage device 618 may include a machine-readable storage medium 628 that stores the cluster naming instructions 625 (e.g., software) embodying any one or more of the methodologies of functions described herein. The cluster naming instructions 625 may also reside, completely or at least partially, within the main memory 604 or within the processing device 602 during execution thereof by the computer system 600; the main memory 604 and the processing device 602 also constituting machine-readable storage media. The cluster naming instructions 625 may further be transmitted or received over a network 620 via the network interface device 608.

While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable storage medium includes any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “generating,” “extracting,” “assigning,” “causing,” “receiving,” “transmitting,” “obtaining,” “ranking,” “identifying,” “associating,” “presenting,” “displaying,” “selecting,” “determining,” “clustering,” “modifying,” “providing,” “installing,” “activating,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission, or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

1. A method, comprising:
generating, via a clustering technique, a plurality of clusters based on the plurality of user queries;
extracting, via a keyword extraction technique, a set of keywords from user queries in each cluster in the plurality of clusters;
ranking each keyword in the set of keywords based on an importance of a word for a cluster adjusted for frequency of the word;
assigning, by a processing device and based on a top ranked keyword in the set of keywords, a name to each cluster in the plurality of clusters based on the set of keywords for each cluster in the plurality of clusters;
causing each cluster in the plurality of clusters and the name for each cluster in the plurality of clusters to be presented on a display;
associating the name for each cluster in the plurality of clusters with functionality associated with an application on a user device, wherein the application fails to provide the functionality;
obtaining an indication of a selection of a first name for a first cluster in the plurality of clusters; and
causing, based on the association, the functionality to be provided by the application on the user device.

2. The method of claim 1, further comprising:
receiving, from a plurality of user devices and over a network, the plurality of user queries, wherein the generating the plurality of clusters is based on the received plurality of user queries.

3. The method of claim 1, wherein each user query of the plurality of user queries is set forth to at least one of a cybersecurity application or a search engine associated with a user device, and wherein the name for each cluster in the plurality of clusters is associated with functionality associated with the cybersecurity application.

4. The method of claim 1, further comprising:
obtaining, from a user device, an indication of at least one of:
a first user query in a first cluster in the plurality of clusters is not associated with a first name for the first cluster, or
the first user query in the first cluster is associated with a second cluster in the plurality of clusters;
generating, via the clustering technique and based on the indication, a second plurality of clusters based on the plurality of user queries, wherein the plurality of clusters comprises a first number of clusters and the second plurality of clusters comprises a second number of clusters, wherein the first number of clusters is different from the second number of clusters;
extracting, via the keyword extraction technique, a second set of keywords from second user queries in each cluster in the second plurality of clusters;
assigning a second name to each cluster in the second plurality of clusters based on the second set of keywords for each cluster in the second plurality of clusters; and
causing each cluster in the second plurality of clusters and the second name for each cluster in the second plurality of clusters to be presented on the display.

5. The method of claim 1, further comprising:
ranking each keyword in the set of keywords based on an importance of a word for a cluster adjusted for frequency of the word, wherein the assigning the name to each cluster in the plurality of clusters is based on a top P ranked keywords in the set of keywords, wherein P is a positive integer.

6. The method of claim 1, further comprising:
causing, for a cluster in the plurality of clusters, a user query associated with the cluster to be presented on the display.

7. The method of claim 1, further comprising:
identifying an overlap between a first cluster in the plurality of clusters and a second cluster in the plurality of clusters; and
generating, based on a modification to the clustering technique, a second plurality of clusters based on the plurality of user queries, wherein each cluster in the second plurality of clusters is non-overlapping, and wherein the extracting the set of keywords and the assigning the name to each cluster is based on the second plurality of clusters.

8. The method of claim 1, wherein the clustering technique comprises at least one of:
centroid-based clustering,
density-based clustering,
distribution-based clustering,
hierarchical clustering,
topic modelling, or
graph clustering.

9. The method of claim 1, wherein the keyword extraction technique comprises at least one of:
term frequency,
term frequency-inverse document frequency (TF-IDF),
a bag-of-words model,
cosine similarity, or
Euclidean distance.

10. (canceled)

11. The method of claim 1, further comprising:
generating embeddings for the plurality of user queries, wherein the generating the plurality of clusters is based on the embeddings.

12. The method of claim 1, wherein the causing each cluster in the plurality of clusters and the name for each cluster in the plurality of clusters to be presented on the display comprises at least one of:
presenting each cluster in the plurality of clusters and the name for each cluster in the plurality of clusters to be presented on the display; or
transmitting data to a user device that causes the user device to present each cluster in the plurality of clusters and the name for each cluster in the plurality of clusters on the display.

13. A system, comprising:
a memory; and
a processing device, operatively coupled to the memory, to:
generate, via a clustering technique, a plurality of clusters based on a plurality of user queries;
extract, via a keyword extraction technique, a set of keywords from user queries in each cluster in the plurality of clusters;
ranking each keyword in the set of keywords based on an importance of a word for a cluster adjusted for frequency of the word;
assign, based on a top ranked keyword in the set of keywords, a name to each cluster in the plurality of clusters based on the set of keywords for each cluster in the plurality of clusters;
cause each cluster in the plurality of clusters and the name for each cluster in the plurality of clusters to be presented on a display;
associate the name for each cluster in the plurality of clusters with functionality associated with an application on a user device, wherein the application fails to provide the functionality;
obtain an indication of a selection of a first name for a first cluster in the plurality of clusters; and
cause, based on the association, the functionality to be provided by the application on the user device.

14. The system of claim 13, wherein the processing device is further to:
receive, from a plurality of user devices and over a network, the plurality of user queries, wherein to generate the plurality of clusters, the processing device is to generate the plurality of clusters based on the received plurality of user queries.

15. The system of claim 13, wherein each user query of the plurality of user queries is set forth to at least one of a cybersecurity application or a search engine associated with a user device, and wherein the name for each cluster in the plurality of clusters is associated with functionality associated with the cybersecurity application.

16. (canceled)

17. A non-transitory computer readable medium, having instructions stored thereon which, when executed by a processing device, cause the processing device to:
generate, via a clustering technique, a plurality of clusters based on a plurality of user queries;
extract, via a keyword extraction technique, a set of keywords from user queries in each cluster in the plurality of clusters;
rank each keyword in the set of keywords based on an importance of a word for a cluster adjusted for frequency of the word;
assign, by the processing device and based on a top ranked keyword in the set of keywords, a name to each cluster in the plurality of clusters based on the set of keywords for each cluster in the plurality of clusters;
cause each cluster in the plurality of clusters and the name for each cluster in the plurality of clusters to be presented on a display;
associate the name for each cluster in the plurality of clusters with functionality associated with an application on a user device, wherein the application fails to provide the functionality;
obtain an indication of a selection of a first name for a first cluster in the plurality of clusters; and
cause, based on the association, the functionality to be provided by the application on the user device.

18. The non-transitory computer readable medium of claim 17, wherein the instructions, when executed by the processing device, cause the processing device further to:
receive, from a plurality of user devices and over a network, the plurality of user queries, wherein to generate the plurality of clusters, the instructions, when executed by the processing device, cause the processing device to generate the plurality of clusters based on the received plurality of user queries.

19. The non-transitory computer readable medium of claim 17, wherein each user query of the plurality of user queries is set forth to at least one of a cybersecurity application or a search engine associated with a user device, and wherein the name for each cluster in the plurality of clusters is associated with functionality associated with the cybersecurity application.

20. The non-transitory computer readable medium of claim 17, wherein the instructions, when executed by the processing device, further cause the processing device to:
associate the name for each cluster in the plurality of clusters with functionality associated with an application on a user device, wherein the application fails to provide the functionality;
obtain an indication of a selection of a first name for a first cluster in the plurality of clusters; and
cause, based on the association, the functionality to be provided by the application on the user device.
